(19) United States
(12) Patent Application Publication
(10) Pub. No.: US 2026/0237204 A1
(43) Pub. Date: Aug. 13, 2026

(54) AUTOMATED PHENOTYPING FOR SEED POD SHATTER AND SEED POD DROP

(71) Applicant: PIONEER HI-BRED INTERNATIONAL, INC., JOHNSTON, IA (US)

(72) Inventors: THOMAS ERNST, EDMONTON (CA); IGOR FALAK, GUELPH (CA); SUDHIR SORNAPUDI, JOHNSTON, IA (US); DANIEL JOSEPH STANTON, REDWATER (CA); SARA TIRADO TOLOSA, HAMILTON (CA)

(73) Assignee: PIONEER HI-BRED INTERNATIONAL, INC., JOHNSTON, IA (US)

(21) Appl. No.: 19/155,869

(22) PCT Filed: Feb. 12, 2024
(86) PCT No.: PCT/US2024/015389

§ 371 Date: Aug. 12, 2025

Related U.S. Application Data
(60) Provisional application No. 63/484,545, filed on Feb. 13, 2023.

(51) Int. Cl. G06V 20/10; G06V 10/26; G06V 10/82; G06V 20/60

(52) U.S. Cl. CPC G06V 20/188; G06V 10/26; G06V 10/82; G06V 20/60

(57) ABSTRACT

The present disclosure relates to a method of phenotyping and distinguishing seed pod drop and seed pod shatter for a population of plants. The method comprises obtaining images of the ground in which the population was grown, showing soil, ground cover, and/or plant debris and further showing fallen seed pods and/or fallen seed pod carpels; sending the images to an image processing system; utilizing, via the image processing system, an instance segmentation model to identify and measure dropped seed pods shown in the images; and utilizing, via the image processing system, instance segmentation to identify and measure shattered seed pod carpels shown in the images. The dropped seed pods and shattered seed pods are distinguished from one another and measured separately from one another. Additional methods are provided.

### BACKGROUND OF THE INVENTION

Canola is one of the biggest oilseed crops in the world. A limitation faced during canola production is the risk of seed loss during or before harvesting due to seed pod shatter and/or seed pod drop. There is a need for an efficient way to capture and measure these losses to enable the improvement of genetics in order to reduce losses.

### SUMMARY OF THE INVENTION

Canola is an oil seed crop with high potential for seed pod shatter (“shatter”), seed pod drop (“drop”), and substantial seed losses at the time of harvest. Canola seed loss happens through both shatter and drop. Typical losses may range between 5-10% of potential yield, which is significant economic loss. A 10% yield loss could result in an economic loss of $8000/160 acres. Shatter and drop are distinct genetic traits, so it is difficult to breed for varieties with both reduced shatter and drop without accurately phenotyping both genetic traits and their associated phenotypes.

Canola phenotyping with images taken via proximal sensing has great advantages over traditional phenotyping approaches which involve visual scores taken by experts or the collection and counting of pods and carpels in catch trays. Regarding visual scoring, these methods are not quantitative. Shatter scoring also requires a trained scorer, and drop scoring is often confounded by shatter due to mixed ground cover from the two types of harvest loss. Catch trays attempt to capture a quantitative measurement but are localized, expensive, and difficult to scale for widescale deployment. Past efforts attempting to image and distinguish between shatter and drop without the use of catch trays were not successful. (2010, University of Manitoba, Growing Forward Program, Gulden, Robert “Analysis of images collected in the field was even more challenging. Current software does not have the capacity for shape and size recognition, and it was not possible to adapt the software for rapid pod or seed recognition from field images. Therefore, this method cannot provide rapid and efficient data generation at this time.”)

The present disclosure describes the combination of image capture of the ground between crop rows with automated deep learning image analysis. The disclosed methods greatly improve the efficiency and accuracy of seed loss measurements, without using catch trays. The deep learning-based imaging frameworks disclosed herein precisely identify and segment dropped pods and shattered carpels from the understory proximal images to automate canola seed loss phenotyping. Instance segmentation and identification of shatter and drop (distinguished from one another) was performed with both (1) a Mask R-CNN, Convolutional Neural Network (CNN)-based model and (2) a Mask2former, transformer-based vision model.

Provided herein is a method of phenotyping and distinguishing seed pod drop and seed pod shatter for a population of plants. The method comprises obtaining images of the ground in which the population was grown. The images show soil, ground cover, and/or plant debris and further show fallen seed pods and/or fallen seed pod carpels. The method comprises sending the images to an image processing system. The method comprises utilizing, via the image processing system, an instance segmentation model to identify and measure dropped seed pods shown in the images and utilizing, via the image processing system, instance segmentation to identify and measure shattered seed pod carpels shown in the images. Dropped seed pods and shattered seed pods are distinguished from one another and measured separately from one another.

Provided herein is a method of phenotyping and distinguishing seed pod drop and seed pod shatter for a population of plants. The method comprises obtaining images of the ground in which the population was grown at a first time point. The images show soil, ground cover, and/or plant debris and further show dropped seed pods and/or shattered seed pod carpels. The method comprises obtaining images of the ground in which the population was grown at a second time point. The images show soil, ground cover, and/or plant debris and further show dropped seed pods and/or shattered seed pod carpels. The method comprises sending the images from both the first and second time points to an image processing system. The method comprises utilizing, via the image processing system, an instance segmentation model to identify and measure dropped seed pods shown in the images and utilizing, via the image processing system, instance segmentation to identify and measure shattered seed pod carpels shown in the images. Dropped seed pods and shattered seed pods are distinguished from one another and measured separately from one another.

### BRIEF DESCRIPTION OF DRAWINGS

The present disclosure will be more fully appreciated by reference to the following non-limiting drawings.

FIG. 1A. Shows a canola understory illustration with pod drop and pod shatter in the context of soil, ground cover, plant debris, etc.

FIG. 1B. Shows the same illustration with darker shading to indicate seed pod shatter and lighter shading to indicate seed pod drop.

FIG. 2. Distribution of drop and shatter counts per aera of interest (AOI) in training sets. “gt_shatter” means ground truth for seed pod shatter and “gt_pods” means ground truth for seed pod drop.

FIG. 3. Architecture for Mask R-CNN (above/left of the dotted line) and Mask2former (below/right of the dotted line) instance segmentation models.

### DETAILED DESCRIPTION OF THE INVENTION

Provided herein is a method of phenotyping and distinguishing seed pod drop and seed pod shatter for a population of plants.

As used herein, “seed pod shatter”, “shatter”, “pod shatter”, and the like refer to a type of seed loss in which the two carpels of a seed pod prematurely break apart and are decoupled from the replum layer of the plant pod structure. Thus, after a shatter event, seeds are exposed to the environment and the carpels are separated from the replum layer, likely landing on the ground below the parent plant. This event can lead to loss of agricultural yield when the seeds are an intended product of the harvest. The seeds are not harvestable once they are released and land on the ground.

As used herein, “seed pod drop”, “drop”, “pod drop”, and the like refer to a type of seed loss in which the two carpels of a seed pod remain attached to the replum layer of the pod structure, with the pedicel attached as well, and this unit of carpels, replum, and pedicel are decoupled from the parent plant at the stem. Thus, after a drop event, seeds are not exposed to the environment, and the carpels remain attached to the replum layer of the pod structure, yet the intact pod is nonetheless released, likely landing on the ground below the parent plant. This event can lead to loss of agricultural yield when the seeds are an intended product of the harvest. The seeds are not harvestable once the pod is released and lands on the ground.

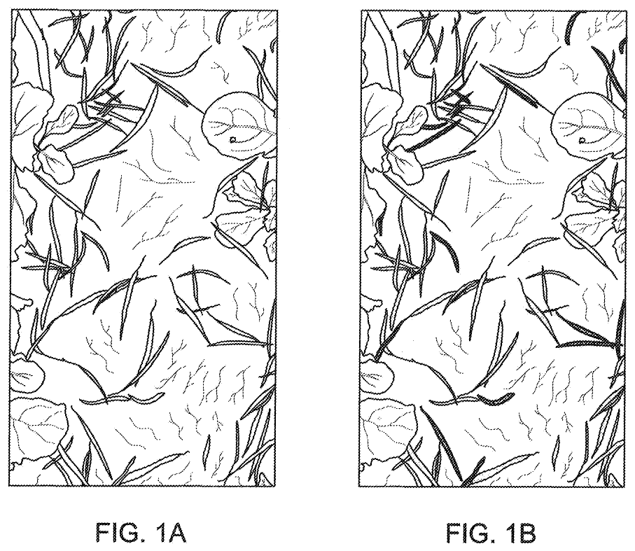

The method comprises obtaining images of the ground in which the population was grown, showing soil, ground cover, and/or plant debris and further showing fallen seed pods and/or fallen seed pod carpels (e.g., shattered pods). In one example, the population of plants may be grown in a field in rows. The images may be taken from below the plant canopy, but above the ground in order to generate an image such as that of FIG. 1A. Such an image is expected to show a background of soil and/or material covering the soil such as plant material, living or dead. In addition, when pod drop and/or pod shatter has occurred, seed pods and/or carpels are expected to be present. Examples of these seed pods and carpels are shown in FIGS. 1A and 1B, with shading indicating the pods and carpels in FIG. 1B. The images can be captured at a distance from the ground which provides sufficient resolution to detect carpels and seed pods.

As discussed below, images may also be obtained after the plant canopy has been removed or reduced (e.g., by cutting, swathing or harvesting).

The method comprises sending the images to an image processing system. The image processor can comprise a general purpose computer capable of receiving the images (e.g., receiving them electronically either via a wired or wireless connection). The general purpose computer can comprise both a CPU and a GPU. Furthermore, the image processing system should be capable of running an image instance segmentation model to detect, identify, discriminate between, and measure shattered carpels and dropped pods.

The method comprises utilizing, via the image processing system, the instance segmentation model to identify and measure dropped seed pods shown in the images; and utilizing, via the image processing system, the instance segmentation model to identify and measure shattered seed pod carpels shown in the images. The use of the instance segmentation model results in the ability to both distinguish shatters from drops and measure individual occurrences of both shatters and drops to determine a measurement for each. A semantic segmentation model would not allow for the distinguishing functionality for the identification of individual occurrences in the same category; therefore instance segmentation is employed. In examples where identification of individual occurrences in the same category is not required, semantic segmentation could be considered.

A feature of this method is that dropped seed pods and shattered seed pods are distinguished from one another and measured separately from one another. The method presented herein is able to measure both phenomena at the same time, under the same conditions, with no additional manual time or effort spent than would be needed to measure either drop or shatter alone.

In some examples, measuring the drops and shatters can comprise the instance segmentation model counting occurrences of drops and occurrences of shatters.

In some examples, measuring the drops and shatters can comprise the instance segmentation model calculating at least one dimension (e.g., a longitudinal length) for a pod or carpel and optionally using the dimension to estimate an area or volume of the seed pod. Such an area, volume, or dimension can optionally be used to estimate seed loss (e.g., by number of seeds or mass of seeds).

In some examples of the method presented herein, the method may be used to phenotype varieties of plants by comparing them to a reference, or control, variety. For example, a variety of interest (e.g., a newly developed or discovered variety) that is expected to have improved (e.g., reduced) drop and/or shatter can be compared to a control or reference variety. Such a method can be coupled with breeding activities and/or trait introgression such that the variety of interest can be a trait donor for other varieties. Accordingly, in some examples, the method can comprise performing the method for two or more different populations of plants and comparing the seed pod drop and/or seed pod shatter phenotypes between the populations. Additionally, the method can comprise selecting an individual population member displaying a decreased seed pod drop rate and/or seed pod shatter rate, compared to a second population, and crossing the individual population member with another plant. For example, selected individuals can be used to perform trait introgression of shatter and/or drop resistance traits.

In some examples of the method, obtaining the images can comprise acquiring the images via a camera. The camera may be present on a mobile device, such as a smartphone (as described in Example 1). The smartphone may be attached to a pole to allow an operator to pass the camera over the ground in which the plants are growing.

In some examples, the images are taken from about 15.24 centimeters (6 inches) to about 91.44 centimeters (36 inches) vertically above the ground. In some examples, the images are taken from about 15.24 centimeters (6 inches) to about 45.72 centimeters (18 inches) vertically above the ground. In some examples, the images are taken from about 30.48 centimeters (12 inches) vertically above the ground. As used herein, “about” and “approximately”, when used in connection with a numerical value, mean plus or minus (e.g., within) 10% of the numerical value.

Alternatively or additionally, a camera may be attached to other devices such as a combine. Attachment to a combine can allow for convenient acquisition of images of the ground immediately before and/or after harvest. In some examples, the lens being used to capture the image from a combine can be approximately 19 inches from the ground and/or can be situated at a height appropriate to capture approximately 1 square meter of ground.

Alternatively or additionally, images can be obtained via a drone (e.g., an unmanned aerial vehicle). In these examples, the drone may obtain images of the plant canopy at various time points to track loss of seed pods. Alternatively or additionally, the drone may obtain images of the ground before and/or after the canopy has been removed or reduced (e.g., by cutting, swathing, or harvesting).

Alternatively or additionally, images can be obtained robotically (e.g., via a camera attached to a robotic vehicle capable of traversing the field between rows of crops).

In some examples, the method can comprise inducing pod shatter and/or pod drop by mechanically contacting a plant. In such examples, seed loss can be induced in a repeatable way to compare varieties' resistances to seed loss. In such examples, the imaging device capturing the images (e.g., an optical, hyperspectral, or multispectral camera) can be mounted on a vehicle or manual tool comprising a member capable of applying a force to a plant to induce seed pod shatter and/or seed pod drop. The imaging device can be mounted in a position below the plant canopy to obtain the images of the dropped and/or shattered pods induced by the contact. The images can then be processed by the instance segmentation model to measure the drops and shatters. In some examples, images can be captured before and after the contacting in order to assess the amount of seed loss induced by the contacting vs that which has already occurred.

In another example, images may also be obtained manually.

As used herein, “obtaining images”, “imaging”, “images” and the like refer to visible light images (e.g., traditional or digital photography, where pixels are assigned RGB values). Also encompassed is multispectral or hyperspectral imaging data, regardless of whether the output is an “image” in common terms.

In some examples of the provided method can comprise obtaining images as RGB data via a digital camera. In other examples, obtaining images can comprise collecting hyperspectral or multispectral imaging data. In some examples, a drone can capture hyperspectral or multispectral imaging data. In some examples, a drone can capture optical RGB imaging data.

In some examples, the method can comprise obtaining images at multiple time points. For example, images can be obtained before harvest. Obtaining images before harvest can allow for conclusions to be made about how much pod shattering and/or pod dropping occurred as a result of events before harvesting. In another example, images can be obtained after harvest. Obtaining images after harvest can allow for observations of pod shattering and/or pod dropping after harvesting. In another example, images can be obtained both before and after harvest. Obtaining images before and after harvest can allow for conclusions to be made about how much pod shattering and/or pod dropping occurs as a result of harvesting or as a result of events before harvesting.

In another example where images are obtained at multiple time points, images can be obtained before and/or after a weather event. A “weather event” is any natural meteorological activity that results in sustained wind, hail, and/or rain that contributes to pod drop or shatter in excess of what would occur without the weather event. A weather event also includes periods of drought or extreme temperature changes (e.g., at or above 37.8° C. (100° F.) or at or below 0° C. (32° F.)) that contribute to excess seed loss via drops and/or shatters.

For example, if a thunderstorm is known to be approaching a field, images obtained before the storm can be analyzed by the instance segmentation model, and after the storm additional images can be obtained and analyzed. Such a method allows for seed loss due to weather events to be calculated.

In another example, natural or simulated (e.g., withholding water) desiccation could be used to cause or contribute to shatter and/or drop, with corresponding before and after imaging.

In some examples of the method, the population of plants can comprise any plants which produce seeds in a pod and where the seeds are a desired agricultural product. In some examples, the population of plants can comprise plants of the Brassica genus (e.g., canola, mustard), pea plants, and/or soybean plants. In some examples, the population of plants can comprise canola plants.

In some examples of the method, data separate from imaging data can be obtained. Such data can inform the skilled artisan regarding the environmental conditions the population of plants experiences during growth. For example seed loss in response to environmental stressors can be assessed. In some examples, data can be obtained regarding one or more of: soil moisture, temperature, soil nutrient status, pest activity, and disease activity. These measurements can be obtained at one or more time points and/or can be made to coincide with obtaining the images at the same one or more time points.

In some examples, the method can use an instance segmentation model that comprises a convolutional neural network-based model or a complete transformer-based model. For example, Mask R-CNN can be employed or Mask2former can be employed. In some examples, the instance segmentation model can comprise (a) a pixel decoder function and a transformer decoder or (b) a feature pyramid network, a region proposal network, and a fully convolutional network.

In particular examples the instance segmentation model comprises a convolutional neural network-based model, the instance segmentation model comprises a feature pyramid network, a region proposal network, and a fully convolutional network, and the instance segmentation model comprises a Mask R-CNN architecture. Such a method can be used when increased detection of shatter is desired (e.g., when shatter is more prevalent than drop).

When training the instance segmentation model, benefits can be found by challenging the model with certain types of imaging conditions that may make detecting and distinguishing drop and shatter more difficult. In some examples, the instance segmentation model can be trained using images showing one or more of: post-harvest debris, under canopy debris, germinated cotyledons that partially obscures the dropped pods and shattered carpels, and dried leaf litter and shadows. In some examples, the instance segmentation model can be trained using images showing post-harvest debris, under canopy debris, germinated cotyledons that partially obscures the dropped pods and shattered carpels, and dried leaf litter and shadows.

In some examples, measurement of dropped seed pods and/or shattered seed pod carpels can comprise preprocessing the images to produce a plurality of smaller sub-images before dropped seed pods and shattered seed pods are identified and measured. The preprocessing step can break larger images (e.g., larger numbers of pixels) down into smaller sub-images. This can lead to benefits in performance for the instance segmentation model. Without wishing to be bound by theory, it is expected that the benefits arise because the dropped/shattered pods occupy a larger percent of the sub-image, compared to the original image.

Preprocessing can comprise a sliding window approach. For example, each image can be padded with zeros at the bottom right to ensure full-sized window extractions during sliding. In one example, a 1024×1024 window can be glided across each padded image, extracting non-overlapping sub-images with a stride of 1024 pixels. Each resulting sub-image can inherit the label of the original image, facilitating analysis of smaller, manageable regions and consistent data dimensions. The specific window size and stride can be chosen to improve performance of the model, while zero-padding can maintain image information at the boundaries. This approach can allow effective extraction of localized features and patterns from relatively large images for further analysis or model training.

In some examples, when pre-processing is employed, a postprocessing step can also be employed to generate human-viewable, originally sized images with pod drops and/or shatters labeled by the instance segmentation model. First the model's instance segmentation predictions can be overlayed onto each sub-image. Then, the sub-images can be arranged in their original positions and any padding can be removed. The merged image can be mapped with its respective original image dimensions to validate the procedure. The full-size image with its stitched-in predictions can be exported.

The present disclosure will be more fully understood by reference to the following clauses.
1. A method of phenotyping and distinguishing seed pod drop and seed pod shatter for a population of plants, the method comprising:
   obtaining images of the ground in which the population was grown, showing soil, ground cover, and/or plant debris and further showing fallen seed pods and/or fallen seed pod carpels;
   sending the images to an image processing system;
   utilizing, via the image processing system, an instance segmentation model to identify and measure dropped seed pods shown in the images; and
   utilizing, via the image processing system, the instance segmentation model to identify and measure dropped seed pod carpels shown in the images,
   wherein dropped seed pods and shattered seed pods are distinguished from one another and measured separately from one another.
2. The method of clause 1, further comprising performing the method for two or more different populations of plants and comparing the seed pod drop and/or seed pod shatter phenotypes between the populations.
3. The method of clause 2, further comprising selecting an individual population member displaying a decreased seed pod drop rate and/or seed pod shatter rate and crossing the individual population member with another plant.
4. The method of any one of clauses 1-3, wherein the images are obtained as RGB data.
5. The method of any one of clauses 1-3, wherein the images are obtained as hyperspectral or multispectral imaging data.
6. The method of any one of clauses 1-5, wherein the images are obtained after harvest of the plants.
7. The method of any one of clauses 1-5, wherein the images are obtained before harvest of the plants.
8. The method of any one of clauses 1-7, wherein images are obtained at multiple time points and seed pod drop and/or seed pod shatter are measured at each time point.
9. The method of any one of clauses 1-8, further comprising obtaining data regarding one or more of: soil moisture, temperature, soil nutrient status, pest activity, and disease activity at one or more time points.
10. The method of any one of clauses 1-9, wherein images are obtained before and after a weather event.
11. The method of any one of clauses 1-10, wherein the images are taken from about 15.24 centimeters (6 inches) to about 91.44 centimeters (36 inches) vertically above the ground.
12. The method of any one of clauses 1-11, wherein the population comprises plants of the Brassica genus, pea plants, and/or soybean plants.
13. The method of clause 12, wherein the population comprises canola plants.
14. The method of any one of clauses 1-13, wherein the images are obtained robotically.
15. The method of any one of clauses 1-13, wherein the images are obtained manually.
16. The method of any one of clauses 1-15, wherein the instance segmentation model comprises a convolutional neural network-based model or complete transformer-based model.
17. The method of any one of clauses 1-16, wherein the instance segmentation model comprises (a) a pixel decoder function and a transformer decoder or (b) a feature pyramid network and a region proposal network.
18. The method of any one of clauses 1-17, wherein the instance segmentation model comprises a convolutional neural network-based model;
   wherein the instance segmentation model comprises a feature pyramid network, a region proposal network, and a fully convolutional network; and
   wherein the instance segmentation model comprises a Mask R-CNN architecture.
19. The method of clause 18, wherein the population comprises elevated seed pod shatter.
20. The method of any one of clauses 1-19, wherein the instance segmentation model was trained using images showing one or more of: post-harvest debris, under canopy debris, germinated cotyledons that partially obscures the dropped pods and shattered carpels, and dried leaf litter and shadows.
21. The method of any one of clauses 1-20, wherein the instance segmentation model was trained using images showing post-harvest debris, under canopy debris, germinated cotyledons that partially obscures the dropped pods and shattered carpels, and dried leaf litter and shadows.
22. The method of any one of clauses 1-21, wherein the images are obtained by a device or vehicle comprising an imaging device and a member capable of applying a force to a plant to induce seed pod shatter and/or seed pod drop, wherein the imaging device is mounted in a position below the plant canopy to obtain the images of the dropped and/or shattered pods on the ground for use by the instance segmentation model.
23. A method of phenotyping and distinguishing seed pod drop and seed pod shatter for a population of plants, the method comprising:
   obtaining images of the ground in which the population was grown at a first time point, wherein the images show soil, ground cover, and/or plant debris and further show dropped seed pods and/or shattered seed pod carpels;
   obtaining images of the ground in which the population was grown at a second time point, wherein the images show soil, ground cover, and/or plant debris and further show dropped seed pods and/or shattered seed pod carpels;
   sending the images from both the first and second time points to an image processing system;
   utilizing, via the image processing system, an instance segmentation model to identify and measure dropped seed pods shown in the images; and
   utilizing, via the image processing system, the instance segmentation model to identify and measure dropped seed pod carpels shown in the images,
   wherein dropped seed pods and shattered seed pods are distinguished from one another and measured separately from one another.
24. The method of clause 23, wherein the first time point is before harvesting the population and the second time point is after harvesting the population.
25. The method of clause 23, wherein the first time point is before a weather event and the second time point is after a weather event.
26. The method of any one of clauses 23-25, further comprising performing the method for two or more different populations of plants and comparing the seed pod drop and/or seed pod shatter phenotypes between the populations.
27. The method of clause 26, further comprising selecting an individual population member displaying a decreased seed pod drop rate and/or seed pod shatter rate and
   crossing the individual population member with another plant.
28. The method of any one of clauses 23-27, wherein the images are obtained as RGB data.
29. The method of any one of clauses 23-27, wherein the images are obtained as hyperspectral or multispectral imaging data.
30. The method of any one of clauses 23-29, further comprising obtaining data regarding one or more of: soil moisture, temperature, soil nutrient status, pest activity, and disease activity.
31. The method of any one of clauses 23-30, wherein the images are taken from about 15.24 centimeters (6 inches) to about 91.44 centimeters (36 inches) vertically above the ground.
32. The method of any one of clauses 23-31, wherein the population comprises plants of the Brassica genus, pea plants, and/or soybean plants.
33. The method of clause 23-32, wherein the population comprises canola plants.
34. The method of any one of clauses 23-33, wherein the images are obtained robotically.
35. The method of any one of clauses 23-33, wherein the images are obtained manually.
36. The method of any one of clauses 23-35, wherein the instance segmentation model comprises a convolutional neural network-based model or complete transformer-based model.
37. The method of any one of clauses 23-36, wherein the instance segmentation model comprises (a) a pixel decoder function and a transformer decoder or (b) a feature pyramid network and a region proposal network.
38. The method of any one of clauses 23-37,
   wherein the instance segmentation model comprises a convolutional neural network-based model;
   wherein the instance segmentation model comprises a feature pyramid network, a region proposal network, and a fully convolutional network; and
   wherein the instance segmentation model comprises a Mask R-CNN architecture.
39. The method of clause 38, wherein the population comprises elevated seed pod shatter.
40. The method of any one of clauses 23-39, wherein the instance segmentation model was trained using images showing one or more of: post-harvest debris, under canopy debris, germinated cotyledons that partially obscures the dropped pods and shattered carpels, and dried leaf litter and shadows.
41. The method of any one of clauses 23-40, wherein the instance segmentation model was trained using images showing post-harvest debris, under canopy debris, germinated cotyledons that partially obscures the dropped pods and shattered carpels, and dried leaf litter and shadows.
42. The method of any one of clauses 23-41, wherein the images are obtained by a device or vehicle comprising an imaging device and a member capable of applying a force to a plant to induce seed pod shatter and/or seed pod drop, wherein the imaging device is mounted in a position below the plant canopy to obtain the images of the dropped and/or shattered pods on the ground for use by the instance segmentation model.
43. The method of any one of claims 1-42, wherein measurement of dropped seed pods and/or shattered seed pod carpels comprises counting the pods and/or carpels.
44. The method of any one of claims 1-43, wherein measurement of dropped seed pods and/or shattered seed pod carpels comprises determining a dimension or area for the pods and/or carpels.
45. The method of any one of claims 1-44, wherein measurement of dropped seed pods and/or shattered seed pod carpels comprises preprocessing the images to produce a plurality of smaller sub-images before dropped seed pods and shattered seed pods are identified and measured.

### EXAMPLES

The present disclosure will be more fully appreciated with reference to the following non-limiting examples.

### Example 1—Deep Learning Based Precision Phenotyping for Canola Breeding—Materials and Methods

A smartphone was attached to a pole device. A pig-tail wire was also attached to the end of the pole that was coupled to the smartphone to measure and/or calibrate the distance to the ground from the camera of the smartphone (approximately 30.48 centimeters (12 inches)). The area being photographed was estimated by taking initial images of crossed rulers on the ground. The calculated area was used to estimate drop and shatter measure and number of pods per square meter.

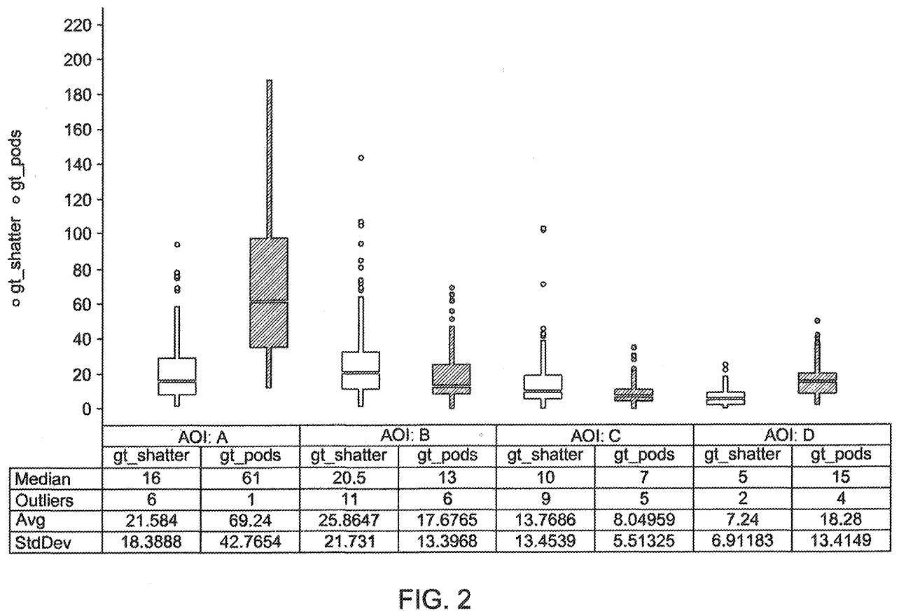

Image data was collected from four areas of interest (AOI): A, B, C, and D. These locations comprise good variation in field environments and have several instances of pod drops and shatter. See FIG. 2. The details of the dataset considered for model training and testing are shown in Table 1.

A total of 562 images were annotated, out of which, 494 images were considered for model training (445 images) and validation (49 images) with a 90-10 split. The rest of the image data was used as a hold-out test dataset for model evaluation. The training dataset alone contained 11,219 pod drops and 8,578 shatter instances (see Table 1).

Different AOI's had differing prevalence of challenging conditions. Namely, A had low shatter pressure and artificially generated pod drops, B had mixed shatter and pod drops, C had low pod drop pressure with less shatter and a high prevalence of shadows. Challenges in the datasets, at all AOI's, included one or more of post-harvest debris, under canopy debris, germinated cotyledons that obscured the drops and shatters, and dried leaf litter and shadows. Inclusion of images in the training set that reproduced these challenges proved beneficial in properly teaching the model to identify, distinguish, and independently measure drops and shatters.

TABLE 1
Canola understory image dataset

| AOI | Image Count | Pod Drop Instances | Shatter Instances |
|---|---|---|---|
| A | 125 | 8655 | 2698 |
| B | 170 | 3005 | 4397 |
| C | 242 | 1948 | 3332 |
| D | 25 | 457 | 181 |

### Example 2—Deep Learning Based Precision Phenotyping for Canola Breeding—Model Architecture and Training

Two instance segmentation models, Mask R-CNN and Mask2former, were trained on canola field images with pod drop and pod shatter and their corresponding human labeled annotations. Pod drop was assessed by locating whole pods on the ground also containing a pedicel, and shattered pods were assessed by located pod carpels.

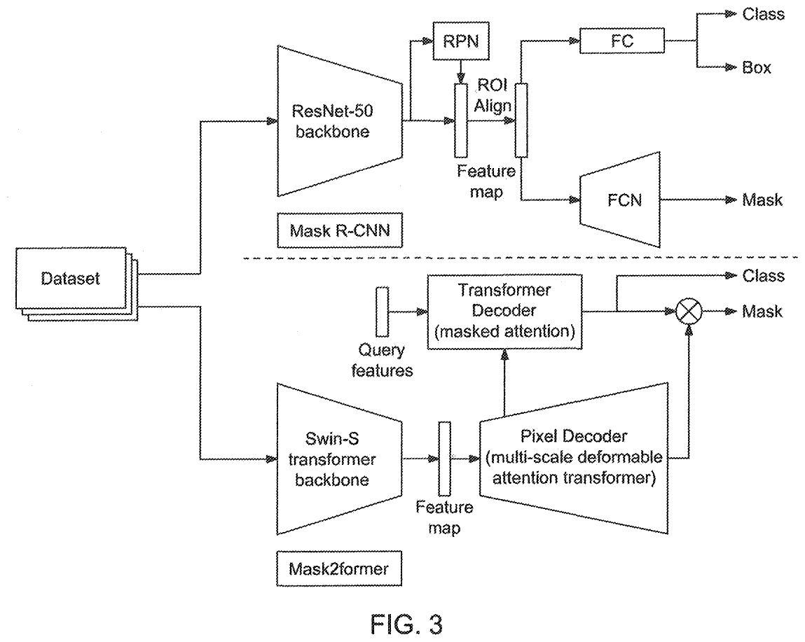

Both instance segmentation models are shown in FIG. 3. Mask R-CNN is a complete Convolutional Neural Network (CNN) based model, and Mask2former is complete transformer-based model.
1) Mask R-CNN: Mask R-CNN, shown in FIG. 3 (top/left), is developed on top of Faster R-CNN with an added fully convolutional network (FCN) to predict masks working in parallel to existing fully connected (FC) layer for class and box determination. It is a two-stage network: Stage I identifies possible Region of Interests (RoI) or anchors in an image with help of a Feature Pyramid Network (FPN) and Region Proposal Network (RPN). A ResNet-50 model was used as backbone to extract inherent multi-scale semantic features with lateral connections. This architecture forms an FPN. The anchors generated by RPN were post-processed to filter out redundant anchors using Non-Maximum Suppression algorithm (NMS). Stage II produces the classification, bounding-box regression, and pixel-level segmentation results. Small feature maps were extracted from each candidate RoI using RoIAlign operation. These feature maps were fed through FC and FCN layers to predict the object instances in the image.
2) Mask2former: A masked-attention mask transformer (Mask2former), shown in FIG. 3 (bottom/right), is designed to address universal image segmentation problem (semantic, instance or panoptic) with a single model. It adopts a meta-architecture with a backbone, a pixel decoder and a Transformer decoder. A smaller version of a hierarchical vision transformer with shifting windows (Swin-S) was utilized, where self-attention is based on the shifted window, as backbone feature extractor. A multi-scale deformable attention (MSDeformAttn) transformer is used as a default pixel decoder to generate high-resolution per-pixel embeddings from the feature maps. The transformer decoder uses masked attention instead of standard cross-attention to decode intermediate layer embeddings as well as object queries to output class labels and masks.

Model Training, the PyTorch object detection library was used to train Mask R-CNN and MMDetection library based on PyTorch to train the Mask2former model.

Training Mask R-CNN involved preloading model weights with COCO weights and training for a total of 100 epochs. The model was optimized using stochastic gradient descent (SGD) method with 0.9 momentum and 0.0005 weight decay. The initial learning rate was set to 0.01, using a step learning rate scheduler to decay by a factor of 0.1, with a step size of 30 epochs, and minibatch of size 32.

Mask2former was finetuned with Swin-S backbone with window size 7 and initialized with COCO pretrained weights. The number of decoder object queries was set to 100. AdamW optimizer was used with learning rate 0.0001 and weight decay 0.05. The learning rate was configured to step with 0.1 factor. The model was setup to train with iteration-based runner and maximum iterations was set to 368,750.

Image augmentations were used to avoid the overfitting problem. Operations like random flip, random crop and Gaussian blur were applied. Synthetic images were also generated by copy-pasting the pod and shatter instances onto clean ground images, though no added benefit with this type of image augmentation was observed. It is because the provided images from four locations were diverse and complex enough to train a generalized model. The original and augmented images were normalized before feeding them to the model for training and testing.

Hardware. The models were trained on a cloud container with single node NVIDIA A100 Tensor Core 80 GB GPU and AMD EPYC 7513 32-Core CPU. Average inference time on single image was 0.72 seconds and 1.0 second for Mask R-CNN and Mask2former, respectively.

### Example 3—Deep Learning Based Precision Phenotyping for Canola Breeding—Example Results

Both instance segmentation models, Mask R-CNN and Mask2former, were tested on the canola dataset described in Example 1. Although the data comes with its inherent challenges, the models have learned enough to identify the instances under various environments.

The instance segmentation results are reported in standard metrics provided by the COCO challenge for detection evaluation. See Table 2. mAP represents mean average precision with mean over ten 0.50:0.95 Intersection-Over-Union (IoU) thresholds averaged across the two classes. The mean average recall (mAR) is average recall value given 100 detections per image, averaged over categories and IoUs. The superscript ‘B’ and ‘S’ denote metrics for bounding box detection and segmentation, respectively.

The metrics were tabulated based on the predictions for the hold-out test dataset containing a total of 68 images from four locations, shown in Table 2. The Mask R-CNN model is a complete CNN-based architecture with ResNet-50 feature extractor and model train memory is 4.4 GB, whereas the Mask2former model is a complete transformer-based architecture with Swin-177 S backbone and computationally costly with 18.8 GB train memory. This is due to the fact that self-attention in transformers is both memory and compute intensive to model full-image contextual information.

TABLE 2
Model evaluation on test dataset

| | | Train | | | | |
|---|---|---|---|---|---|---|
| Architecture | Backbone | Memory | mAP^{B} | mAR^{B} | mAP^{S} | mAR^{S} |
| Mask R- | ResNet-50 | 4.4 GB | 36.7 | 44.1 | 22.3 | 28.6 |
| CNN | | | | | | |
| Mask2former | Swin-S | 18.8 GB | 27.6 | 38.2 | 28.0 | 35.4 |

Based on Table 2, the Mask2former model outperformed the Mask R-CNN model in terms of pixel level detection or segmentation, but Mask R-CNN was superior in object detection with bounding box prediction. The bounding box results for Mask2former is almost equivalent to its segmentation results, because the there is no separate branch for bounding box in Mask2former—the boxes were inferred from the segmentation masks. On the contrary, Mask R-CNN has a separate bounding box regression branch, along with a mask prediction branch and masks predicted by Mask-RCNN are of poor quality at pixel level comparison to ground truth. This is clearly understandable when considering the mAP at single IoU threshold of 0.5 188 (mAPIoU=0.5), where Mask R-CNN has mAPIoU=0.5 of 22.3 and Mask2former is 27.6.

The test results for each location are reported in Table 3. When analyzed with Table 1, it indicates that the AOIs with high pod drop, and low shatter pressure have better prediction results. Both models predict pod drops consistently. When it comes to shatter detection Mask R-CNN seems to do a better job upon visual inspection of the results. In this regard, Mask R-CNN can be considered as the best model for seed loss estimation problem.

TABLE 3
Location-wise test result analysis

| | Test | Mask R- | Mask R- | Mask2former | Mask2former |
|---|---|---|---|---|---|
| AOI | images | CNN mAP^{S} | CNN MAR^{S} | mAP^{S} | MAR^{S} |
| A | 20 | 31.9 | 37.7 | 29.4 | 34.9 |
| B | 20 | 17.6 | 24.8 | 30.9 | 40.5 |
| C | 20 | 9.1 | 13.9 | 18.1 | 28.1 |
| D | 8 | 12.9 | 17.1 | 22.3 | 29.5 |

Presented herein is a deep learning-based solution with instance segmentation approach to determine the seed loss from proximal sensing imagery for canola phenotyping. Both the models, Mask R-CNN (CNN-based) and Mask2former (Transformer-based), are robust solutions to the problem. Mask2former was observed to deliver accurate segmentation results, whereas Mask R-CNN delivered accurate bounding box detection of the pod drop and shatter instances. Transformers become more accurate with more data, outperforming CNNs, and they are observed to have quantitatively different features in that it incorporates more global information than CNN at lower layers. Therefore, further training of Mask2former may improve its accuracy of shatter detection.

### Example 4—Deep Learning Based Precision Phenotyping for Canola Breeding Including Image Preprocessing

The work of Example 3 was repeated using an image preprocessing step to increase the relative size of seed pod drops and shatters from approximately 0.01% of the size of the original image to approximately 0.10% of the sub-images. This enables the models to understand the localized feature patterns and better refine the object detections. We observed an improved detection rate by employing this strategy. We incorporated a post-processing step to merge the overlayed model predictions for visualization purposes.

We report the instance segmentation results with AP (average precision) and AR (average recall) most popular metric used by the benchmark challenges such as COCO, ImageNet, Google Open Image challenge, etc. for detection evaluation. Unless otherwise specified, AP is computed on 0.5 Intersection-Over-Union (IoU) threshold averaged across the two classes. AR is average recall value given 100 detections per image, averaged over categories and ten IoUs ranging from 0.5 to 0.95. The superscript ‘B’ and ‘S’ denote metrics for bounding box detection and segmentation, respectively.

The metrics were tabulated based on the predictions for the hold-out test dataset containing a total of 68 images from four locations, shown in Table 4. The Mask R-CNN model is a complete CNN-based architecture with ResNet-50 feature extractor and model train memory is 4.4 GB, whereas the Mask2former model is a complete transformer-based architecture with Swin-177 S backbone and computationally costly with 18.8 GB train memory. This is due to the fact that self-attention in transformers is both memory and compute intensive to model full-image contextual information.

TABLE 4
Model evaluation on test dataset

| | | Train | | | | |
|---|---|---|---|---|---|---|
| Architecture | Backbone | Memory | mAP^{B} | mAR^{B} | mAP^{S} | mAR^{S} |
| Mask R- | ResNet-50 | 4.4 GB | 53.2 | 44.1 | 49.4 | 28.6 |
| CNN | | | | | | |
| Mask2former | Swin-S | 18.8 GB | 45.1 | 38.2 | 50.8 | 35.4 |

Based on Table 4, the Mask2former model outperformed the Mask R-CNN model in terms of pixel level detection or segmentation, but Mask R-CNN was superior in object detection with bounding box prediction. The bounding box results for Mask2former is almost equivalent to its segmentation results, because the there is no separate branch for bounding box in Mask2former—the boxes were inferred from the segmentation masks. On the contrary, Mask R-CNN has a separate bounding box regression branch, along with a mask prediction branch and masks predicted by Mask-RCNN are of poor quality at pixel level comparison to ground truth. This is clearly understandable when we compared the AP of Mask R-CNN (49.4) and Mask2former (45.1).

TABLE 5
Location-wise test result analysis

| | Test | Mask R- | Mask R- | Mask2former | Mask2former |
|---|---|---|---|---|---|
| AOI | images | CNN mAP^{S} | CNN MAR^{S} | mAP^{S} | MAR^{S} |
| A | 20 | 58.9 | 37.7 | 52.4 | 34.9 |
| B | 20 | 44.6 | 24.8 | 44.9 | 40.5 |
| C | 20 | 26.1 | 13.9 | 28.1 | 28.1 |
| D | 8 | 32.9 | 17.1 | 33.3 | 29.5 |

Incorporating a preprocessing step can improve performance, for both the Mask R-CNN and Mask2former models.

### Example 5—Model Validation

The model was used to measure pod drop and shatter in three new AOIs. Model predictions were compared to ground truth (e.g., images annotated by humans). Data are presented in Tables 6 and 7 for seed pod shatter and seed pod drop, respectively. Images and analysis were performed as previously described. The Mask-R-CNN model was used to reduce the need for compute resources. Best Linear Unbiased Estimates (BLUEs) were calculated for scatter plots of predictions vs. ground truth for each of drops and shatters in each AOI (Tables 7 and 8, last row).

TABLE 7
Seed pod shatter data

| | Ground | Model | Ground | Model | Ground | Model |
|---|---|---|---|---|---|---|
| | truth for | prediction | truth for | prediction | truth for | prediction |
| | AOI E | for AOI E | AOI F | for AOI F | AOI G | for AOI G |
| Count | 153 | 153 | 152 | 152 | 156 | 156 |
| Median | 123.412 | 156.259 | 36.09 | 63.9204 | 60.793 | 69.6885 |
| Outliers | 1 | 1 | 2 | 2 | 3 | 1 |
| Best | 0.866 | | 0.864 | | 0.828 | |
| Linear | | | | | | |
| Unbiased | | | | | | |
| Estimate- | | | | | | |
| R squared | | | | | | |
| value | | | | | | |

TABLE 8
Seed pod drop data

| | Ground | Model | Ground | Model | Ground | Model |
|---|---|---|---|---|---|---|
| | truth for | prediction | truth for | prediction | truth for | prediction |
| | AOI E | for AOI E | AOI F | for AOI F | AOI G | for AOI G |
| Count | 153 | 153 | 152 | 152 | 156 | 156 |
| Median | 3.382 | 18.3946 | 21.6028 | 26.6647 | 16.1481 | 23.1861 |
| Outliers | 5 | 1 | 1 | 1 | 5 | 1 |
| Best | 0.038 | | 0.668 | | 0.543 | |
| Linear | | | | | | |
| Unbiased | | | | | | |
| Estimate- | | | | | | |
| R squared | | | | | | |
| value | | | | | | |

Performance for seed pod drop was reduced, particularly for AOI E. However, this is explained by a low prevalence of pod drop events in that area. (See median values for pod drop in AOI E (Table 8), compared to other median values in Tables 7 and 8).

1. A method of phenotyping and distinguishing seed pod drop and seed pod shatter for a population of plants, the method comprising:
obtaining images of the ground in which the population was grown, showing soil, ground cover, and/or plant debris and further showing fallen seed pods and/or fallen seed pod carpels;
sending the images to an image processing system;
utilizing, via the image processing system, an instance segmentation model to identify and measure dropped seed pods shown in the images; and
utilizing, via the image processing system, the instance segmentation model to identify and measure dropped seed pod carpels shown in the images,
wherein dropped seed pods and shattered seed pods are distinguished from one another and measured separately from one another.

2. The method of claim 1, further comprising performing the method for two or more different populations of plants and comparing the seed pod drop and/or seed pod shatter phenotypes between the populations.

3. The method of claim 2, further comprising selecting an individual population member displaying a decreased seed pod drop rate and/or seed pod shatter rate, compared to a second population, and
crossing the individual population member with another plant.

4. The method of claim 1, wherein the images are obtained as RGB data.

5. The method of claim 1, wherein the images are obtained as hyperspectral imaging or multispectral data.

6. The method of claim 1, wherein the images are obtained after harvest of the plants.

7. The method of claim 1, wherein the images are obtained before harvest of the plants.

8. The method of claim 1, wherein images are obtained at multiple time points and seed pod drop and/or seed pod shatter are measured at each time point.

9. The method of claim 1, further comprising obtaining data regarding one or more of: soil moisture, temperature, soil nutrient status, pest activity, and disease activity at one or more time points.

10. The method of claim 1, wherein images are obtained before and after a weather event.

11. The method of claim 1, wherein the images are taken from about 15.24 centimeters (6 inches) to about 91.44 centimeters (36 inches) vertically above the ground.

12. The method of claim 1, wherein the population comprises plants of the Brassica genus, pea plants, and/or soybean plants.

13. The method of claim 12, wherein the population comprises canola plants.

14. The method of claim 1, wherein the images are obtained robotically.

15. The method of claim 1, wherein the images are obtained manually.

16. The method of claim 1, wherein the instance segmentation model comprises a convolutional neural network-based model or complete transformer-based model.

17. The method of claim 1, wherein the instance segmentation model comprises (a) a pixel decoder function and a transformer decoder or (b) a feature pyramid network and a region proposal network.

18. The method of claim 1,
wherein the instance segmentation model comprises a convolutional neural network-based model;
wherein the instance segmentation model comprises a feature pyramid network, a region proposal network, and a fully convolutional network; and
wherein the instance segmentation model comprises a Mask R-CNN architecture.

19. The method of claim 18, wherein the population comprises elevated seed pod shatter.

20. The method of claim 1, wherein the instance segmentation model was trained using images showing one or more of: post-harvest debris, under canopy debris, germinated cotyledons that partially obscures the dropped pods and shattered carpels, and dried leaf litter and shadows.

21. The method of claim 1, wherein the instance segmentation model was trained using images showing post-harvest debris, under canopy debris, germinated cotyledons that partially obscures the dropped pods and shattered carpels, and dried leaf litter and shadows.

22. The method of claim 1, wherein the images are obtained by a device or vehicle comprising an imaging device and a member capable of applying a force to a plant to induce seed pod shatter and/or seed pod drop, wherein the imaging device is mounted in a position below the plant canopy to obtain the images of the dropped and/or shattered pods on the ground for use by the instance segmentation model.

23. A method of phenotyping and distinguishing seed pod drop and seed pod shatter for a population of plants, the method comprising:
obtaining images of the ground in which the population was grown at a first time point, wherein the images show soil, ground cover, and/or plant debris and further show dropped seed pods and/or shattered seed pod carpels;
obtaining images of the ground in which the population was grown at a second time point, wherein the images show soil, ground cover, and/or plant debris and further show dropped seed pods and/or shattered seed pod carpels;
sending the images from both the first and second time points to an image processing system;
utilizing, via the image processing system, an instance segmentation model to identify and measure dropped seed pods shown in the images; and
utilizing, via the image processing system, the instance segmentation model to identify and measure dropped seed pod carpels shown in the images,
wherein dropped seed pods and shattered seed pods are distinguished from one another and measured separately from one another.

24. The method of claim 23, wherein the first time point is before harvesting the population and the second time point is after harvesting the population.

25. The method of claim 24, wherein the first time point is before a weather event and the second time point is after a weather event.

26. The method of claim 25, further comprising performing the method for two or more different populations of plants and comparing the seed pod drop and/or seed pod shatter phenotypes between the populations.

27. The method of claim 26, further comprising selecting an individual population member displaying a decreased seed pod drop rate and/or seed pod shatter rate and
crossing the individual population member with another plant.

28. The method of claim 23, wherein the images are obtained by a device or vehicle comprising an imaging device and a member capable of applying a force to a plant to induce seed pod shatter and/or seed pod drop, wherein the imaging device is mounted in a position below the plant canopy to obtain the images of the dropped and/or shattered pods on the ground for use by the instance segmentation model.

29. The method of any one of claims 1-28, wherein measurement of dropped seed pods and/or shattered seed pod carpels comprises counting the pods and/or carpels.

30. The method of any one of claims 1-28, wherein measurement of dropped seed pods and/or shattered seed pod carpels comprises determining a dimension or area for the pods and/or carpels.

31. The method of any one of claims 1-30, wherein measurement of dropped seed pods and/or shattered seed pod carpels comprises preprocessing the images to produce a plurality of smaller sub-images before dropped seed pods and shattered seed pods are identified and measured.
